(19) United States
(12) Patent Application Publication
(10) Pub. No.: US 2003/0145075 A1
(43) Pub. Date: Jul. 31, 2003

(54) Diagnostics and network provisioning tool for bi-directional communication devices

(76) Inventors: David John Weaver, Antwerp (BE); Larry Cecil Brown, Westfield, IN (US)

Correspondence Address: JOSEPH S. TRIPOLI, THOMSON MULTIMEDIA LICENSING INC., 2 INDEPENDENCE WAY, SUITE #2, P. O. BOX 5312, PRINCETON, NJ, 08543-5312, US

(21) Appl. No.: 10/338,125

(22) Filed: Jan. 7, 2003

Related U.S. Application Data
(60) Provisional application No. 60/352,698, filed on Jan. 29, 2002.

(51) Int. Cl. G06F 15/173; H04N 7/173

(52) U.S. Cl. 709/223; 725/111

(57) ABSTRACT

Method and apparatus for performing remote bi-directional communication device diagnostics and network management. The method and apparatus includes retrieving IP addresses dynamically provided to each of a plurality of bi-directional communication devices respectively coupled to at least one termination system (TS). The retrieved IP addresses are associated with respective media access control (MAC) addresses, and an indicia of updated association of retrieved IP addresses and MAC addresses are stored in a local database. An IP address may be remotely accessed from the local database to perform diagnostics for a subscriber bi-directional communication device.

### CROSS REFERENCE TO RELATED APPLICATIONS

This patent application claims the benefit of U.S. Provisional Application serial No. 60/352,698, filed Jan. 29, 2002, which is incorporated herein by reference in its entirety.

### FIELD OF INVENTION

The present invention relates to the field of bi-directional communication devices. More specifically, the present invention relates to bi-directional communication device diagnostic and network provisioning tools.

### DESCRIPTION OF THE BACKGROUND ART

The broadband access market is growing at a rate challenging the abilities of most multiple service operators (MSOs) to provision and manage. With the rapid deployment of broadband devices, customer service centers for these companies must deal with various problems as each new user is introduced to the system. One such problem has been the limited amount of information available to a remotely located customer service representative or to personnel at a customer's site, when a problem arises. The information is usually restricted to the device's MAC address and serial number.

The prior art does include some tools available to customer service desks. Such prior art tools include SNMP “browser” tools such as those offered by SNMPc and MG-SOFT. Other similar tools, more specific to bi-directional communication devices, such as cable modem devices, are offered by cable modem manufacturers (e.g., Toshiba and Motorola). However, a disadvantage common to all the prior art tools is that they require knowledge of a device's IP address to function.

With these prior art tools, the IP address of the device (e.g., cable modem) is used to make simple network management protocol (SNMP) queries to the connected devices. This information is not readily available to a customer service operator. As such, a service representative must spend time searching through other resources to first identify the IP address of the cable modem, before being able to utilize a particular cable modem diagnostic tool. Locating a cable modem's current IP address may be difficult and time consuming, since many of the IP addresses are dynamically generated, which means the IP address may change day to day, or even more frequently.

A second limitation is that the prior art diagnostic tools must be locally installed on each service representatives' computer system. Local installation limits a service representative's ability to access the diagnostic tool from the field, thereby diminishing an MSO's ability to provide high level customer services. Specifically, there is no central database that may be accessed to provide updated information regarding the subscriber's cable modems, the cable modem termination systems (CMTS) at the head-ends, or the interconnectivity therebetween.

Another limitation of the present day diagnostic tools is that they provide information solely for the manufacturer of the device. For example, Toshiba's diagnostic tool will only search for Toshiba manufactured cable modem devices based on the device's unique MAC address, where the first three bytes of the address represent a manufacturer's identification code. As such, the service representatives do not have a full picture of the connectivity and bandwidth usage as between a CMTS at a head-end and the individual subscriber cable modems. Therefore, there is a need for an improved diagnostic tool to assist customer service representatives in providing customer services.

### SUMMARY OF INVENTION

The disadvantages heretofore associated with the prior art, are overcome by the present invention of an apparatus and method for providing a bi-directional communication device (BCD) remote diagnostic network management tool. The method and apparatus includes retrieving IP addresses dynamically provided to each of a plurality of bi-directional communication devices respectively coupled to at least one termination system (TS). The retrieved IP addresses are associated with respective media access control (MAC) addresses, and an indicia of updated association of retrieved IP addresses and MAC addresses are stored in a local database. An IP address may be remotely accessed from the local database to perform diagnostics for a subscriber bi-directional communication device. For example, the local database may be remotely accessed by Customer Service Representatives, and the IP address necessary to perform diagnostics for any given subscriber BCD is available immediately from the local database, given knowledge of only the MAC address which is printed on the label of all BCDs as required by applicable industry standards.

### BRIEF DESCRIPTION OF THE DRAWINGS

The teachings of the present invention can be readily understood by considering the following detailed description in conjunction with the accompanying drawings, in which:

FIG. 1 depicts a block diagram of a cable communications system over which an exemplary embodiment of the present invention is utilized;

FIG. 2 depicts a high-level block diagram of a server system suitable for facilitating a network management tool, in accordance with the principles of the present invention;

FIG. 3 depicts a flow diagram of an exemplary method for acquiring respective IP addresses of a plurality of cable modems, in accordance with the principles of the present invention;

FIG. 4 depicts an exemplary diagnostic tool's cable modem summary screen, in accordance with the principles of the present invention;

FIG. 5 depicts an exemplary diagnostic tool's CMTS registration screen, in accordance with the principles of the present invention;

FIG. 6 depicts an exemplary diagnostic tool's search screen, in accordance with the principles of the present invention;

FIG. 7 depicts an exemplary diagnostic tool's cable modem search screen, in accordance with the principles of the present invention;

FIG. 8 depicts an exemplary diagnostic tool's device summary information screen for a CMTS, in accordance with the principles of the present invention;

FIG. 9 depicts an exemplary diagnostic tool's device summary information screen for a cable modem, in accordance with the principles of the present invention; and

FIG. 10 depicts an exemplary screen 1000 illustrating results of pinging a particular address, in accordance with the principles of the present invention.

To facilitate understanding of the invention, identical reference numerals have been used, where possible, to designate identical elements that are common to the figures.

### DETAILED DESCRIPTION OF THE INVENTION

The present invention comprises a bi-directional communication device (BCD) remote diagnostics network management tool operating in a bi-directional communications environment and corresponding method. For purposes of understanding the invention, the present invention is discussed in terms of a cable communications distribution system. However, the present invention may also be applicable to other bi-directional communication environments, such as satellite communication systems, ADSL, DSL, Dial-up, wireless systems, or any other bi-directional communication environment capable of providing bi-directional communications (e.g., data, multimedia content, and other information) to a plurality of subscriber devices.

The cable modem remote diagnostics network management tool (hereinafter “diagnostics tool”) is preferably a CableLabs Certified CableModem™ compliant tool that may be used to assist cable television system operators and Internet service providers (ISPs) deploying DOCSIS-based products such as cable modems. CableLabs Certified CableModem™ (previously known as DOCSIS (data over cable service interface specifications) compliant) is funded by leading CATV operators who establish specifications that specify modulation schemes and the protocols for exchanging bi-directional signals over cable. The various versions of DOCSIS are incorporated herein by reference in their entirety.

The present invention provides the ability for any authorized customer service representative (CSR) having Internet connectivity and access to a web browser to monitor and gather diagnostic information from any DOCSIS compliant modem. Specifically, the diagnostic tool is centrally located and communicates by simple network management protocol (SNMP) to access management information base (MIB) objects relating to cable modem termination systems (CMTSs), as well as the cable modems respectively coupled to the CMTSs in the system. Information obtained from the MIBs may be used by cable service representatives at a remote location to diagnose and troubleshoot a cable system, including the cable modems in the system.

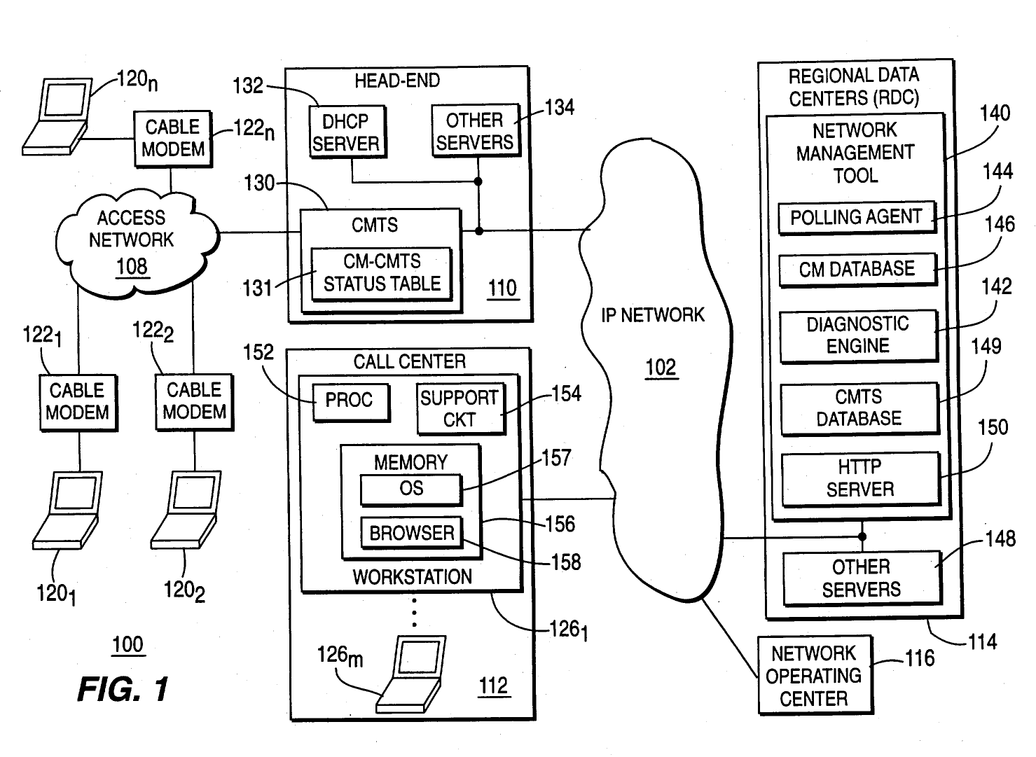

FIG. 1 depicts a block diagram of a cable communications system over which an exemplary embodiment of the present invention is utilized. The bi-directional communications system (e.g., cable modem system) 100 comprises a multiple systems operator (MSO, i.e., cable operator) and a plurality of subscriber premise equipment, which are coupled to the service provider via an access network 108.

The subscriber premise equipment comprises a plurality of user devices 120₁ through 120_{N} (collectively user devices 120) respectively coupled to a plurality of bi-directional communication devices (e.g., cable modems) 122₁ through 122_{N} (collectively cable modems 122). The user devices 120 may be any type of device capable of processing a digitized stream comprising audio, video, and/or data, such as a personal computer (PC), laptop computer, television set, and the like. Each user device 120 is coupled to the access network 108 via a cable modem 122, which connects the user device 120 to the IP network 102 (e.g., the Internet) via the local cable television provider (i.e., MSO).

The cable modems 122 allow the subscribers to download information from the service provider at speeds much faster than the telephone modems. For example, a cable modem 122 can provide connectivity at a rate of three or more megabits per second, as compared to 56 kilobits per second for a telephone modem. One type of cable modem illustratively used in the system 100 is a DCM305 model, manufactured by Thomson Multimedia Inc., of Indianapolis, Ind. It is noted that cable modems (and modem functionality) provided by other manufacturers that are DOCSIS compliant may also be implemented in the system as well.

The service provider comprises at least one head-end 110, at least one call center 112, at least one regional data center (RDC) 114, and a network operating center 116. The head-ends 110, the call centers 112, the regional data centers 114, and the network operating center 116 are coupled to each other through an IP network 102, which may comprise private IP networks and/or public IP networks (e.g., the Internet). The head-ends 110, call centers 112 and RDCs 114 are deployed in various geographic regions to provide connectivity, services, and support to subscribers located in such regions. For example, one or more head-ends 110, an RDC 114, and a call center 112 may be located in proximity to a large subscriber base, such as a city (e.g., San Francisco, Calif.). Other head-ends 110, RDCs 114 and call centers 112 may be provided by the MSO to support other cities or regional areas as required.

The network operating center 116 comprises long-haul network management stations and IP networking personnel and equipment. The network operating center 116 serves the long-haul IP network devices associated with the Internet, i.e. the devices contained within the IP Network cloud 102.

Each head-end 110 comprises at least one termination system (e.g., cable modem termination system (CMTS)) 130, a dynamic host configuration protocol (DHCP) server 132, among other support servers 134, such as trivial file transfer protocol (TFTP), internet time protocol (ITP) and the like. The DHCP server 132 centrally manages and automatically assigns IP addresses to the host devices (i.e., cable modems) coupled to the IP network 102. Specifically, when a cable modem 122 is added, replaced, or moved in the system 100, the DHCP server 132 automatically assigns a new IP address for that cable modem 122.

The other support servers 134 are used to establish connectivity between the cable modems 122 and the IP network 102 during cable modem initialization. Specifically, the other support servers 134 deliver a configuration file and the current date and time to a cable modem 122 each time it initializes. The CMTS 130 exchanges digital signals with cable modems 122 on the cable network 100. The quantity of CMTSs 130 disposed at each head-end 110 is dependent on the number of subscribers being served in a particular geographic region. A single CMTS 130 typically provides connectivity for up to about 8000 cable modems 122. In instances where a geographic region has more than 8000 subscribers, the head-end 110 is provided with additional CMTSs 130, as required.

A data service (e.g., multimedia content) is delivered to a subscriber through an RF path (i.e., channels) over the Access Network 108 via a transmission medium (e.g., hybrid fiber coaxial (HFC) cables or optical fiber cable), coupled to the cable modem 122. It is noted that the cable modem 122 may be installed externally or internally to a subscriber's computer or television set 120, and is connected by a Local Area Networking medium supported by the cable modem 122 and computer or television set (e.g. Ethernet, Universal Serial Bus (USB), 802.11b wireless, Home Phoneline Networking Alliance (HPNA)).

One channel is used for downstream signals from the CMTS 130 to the cable modem 122, while another channel is used for upstream signals from the cable modem 122 to the CMTS 130. When a CMTS 130 receives upstream signals from a cable modem 122, the CMTS 130 processes these signals into Internet Protocol (IP) packets, which are routed over the IP network 102 to a particular destination (e.g., a server having a desired content or a web site). When a CMTS 130 sends downstream signals to a cable modem 122, the CMTS 130 modulates the downstream signals for transmission across the Access Network 108 to the cable modem 122. The cable modem 122 converts the modulated signal to a baseband signal for processing by the user device 120. All cable modems 122 can receive downstream signals from and send upstream signals to the CMTS 130, but not to other cable modems 122 on the line.

The MSO further comprises one or more call centers 112, which comprises a plurality of workstations 126₁ through 126_{M} (collectively workstations 126) that are used by cable service representatives (CSRs) to support the services and products provided to subscriber equipment. The call centers 112 may be located at a single location or are dispersed in various regions to support the subscribers, depending on the size of the MSO and number of subscribers that require support.

Each workstation 126 is a computer device comprising a processor 152, support circuits 154 (e.g., power supplies, cache, I/O circuits, and the like), and memory 156, which interface in a conventional manner as is known in the art. The workstations 126 further comprise an operating system (OS) 157, such as a Microsoft WINDOWS® operating system, and a web browser 158 such as Microsoft's INTERNET EXPLORER® or America On Line's (AOLs) NETSCAPE COMMUNICATOR®. The cable service representatives utilize the web browser 158 to facilitate retrieving information that is specific to the CMTS 130 and/or the cable modems 122 supported by the CMTS 130.

In particular, the cable service representatives (i.e., service operators, technicians, and the like) may use their web browsers 158 to access the regional data centers (RDCs) 114 that are deployed at particular geographic regions to provide support services. For example, an RDC 114 may be deployed to support services for a city such as San Francisco, Calif., as well as the areas (i.e., suburbs) surrounding the city.

Each RDC 114 typically comprises a Network Management Tool (NM Tool) 140. The NM Tool 140 comprises the diagnostic engine 142, a polling agent 144, a dynamic CM database 146, a CMTS database 149, and an http server application 150. In one embodiment, the http server application 150 is a Windows-based http server application. The NM Tool 140 enables remote service representatives to connect to the diagnostic engine 142 through their standard web browsers 158.

Other servers 148 such as web caching servers, MSO or ISP content delivery servers and the like may also be installed at the RDCs 114 to provide regionalized worldwide web content, redundant connectivity, and the like.

The NM tool 140 is a cable modem remote diagnostics tool comprising various web-based screens that display management information base (MIB) objects as defined by the Internet Engineering Task Force (IETF), which authors technical requirements for Internet devices. In particular, the MIB objects are a collection of logically organized information about various devices, such as a cable modem 122, CMTS, routers, or any other device coupled to the Internet. For example, a device such as a cable modem has hundreds of MIB objects that have been specified under the DOCSIS requirements. These MIB objects may be accessed and retrieved via an NM tool 140.

DOCSIS compliant CMTSs 130 are required to support various MIBs. One such MIB supported by each of the CMTSs 130 is a CMTS-CM status table 131. Specifically, each CMTS 130 generates and stores locally a CMTS-CM status table 131, which comprises a list of all the cable modems respectively coupled to the CMTS 130. That is, the CMTS-CM status table 131 identifies the cable modems that it is serving. Each cable modem entry in the CMTS-CM status table 131 has associated fields for providing the cable modem's respective MAC address and last polled IP address, as discussed below in further detail.

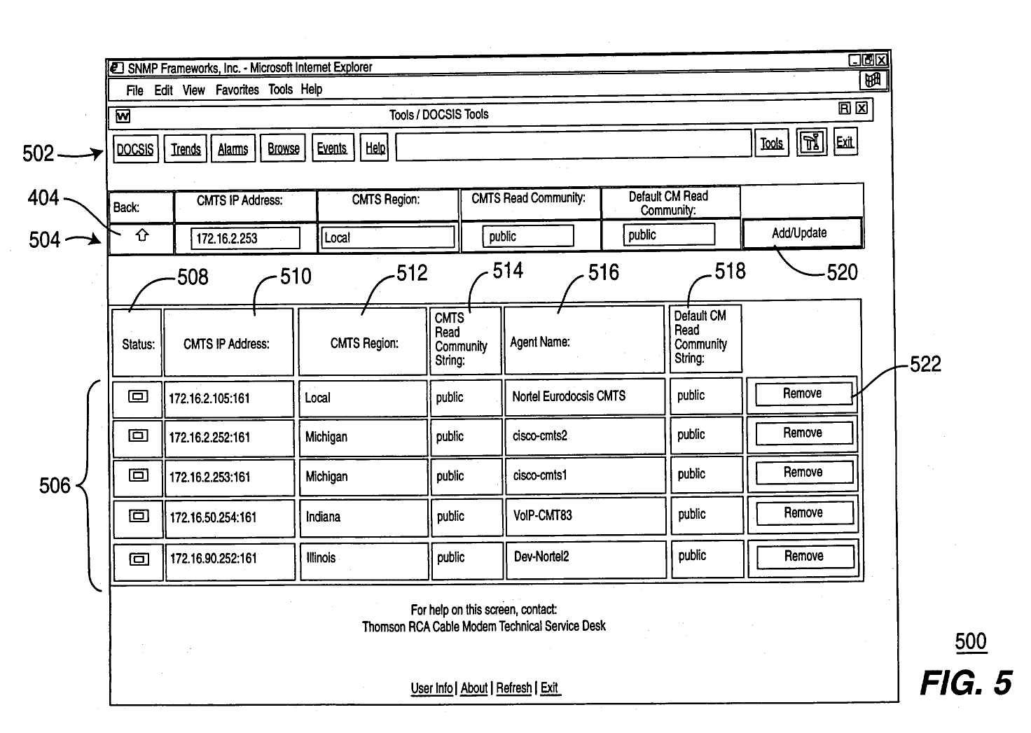

Specifically, during initial installation of the NM tool 140, a diagnostics tool administrator enters into its CMTS Database 149 a list of all the CMTSs 130 (IP addresses and CMTS/CM community strings) in use (see FIG. 5). Once the CMTS information is loaded into the CMTS database 149, the diagnostic engine 142 of the NM tool 140 polls each listed CMTS 130 to retrieve status, IP address and MAC address for each cable modem 122, and stores the results into the CM database 146 of NM tool 140. Recall, that the DHCP server 132 dynamically assigns the IP addresses for the cable modems 122. In one embodiment, the CMTS-CM status table 131 of each CMTS 130 is polled approximately every 15 minutes in a round-robin manner.

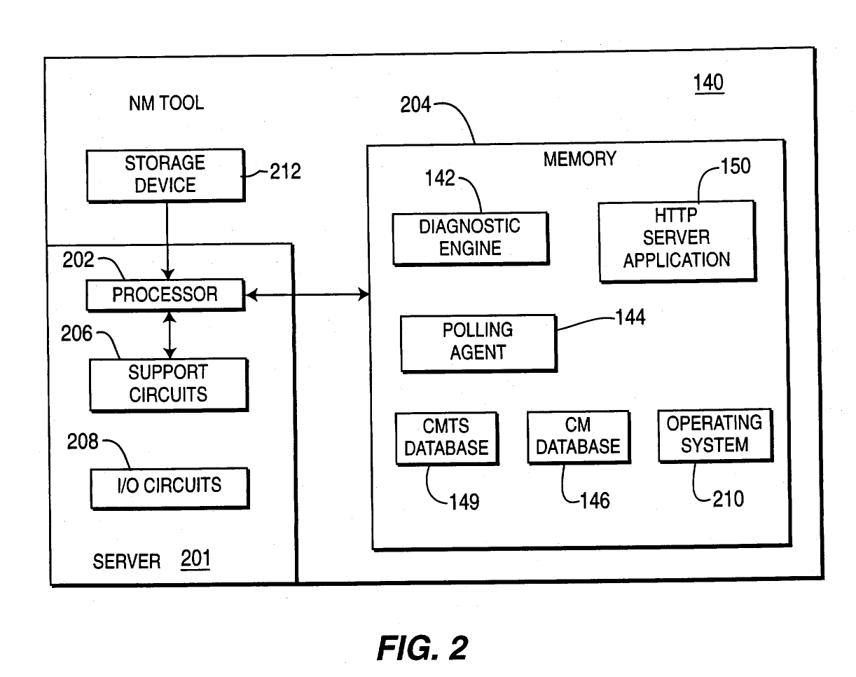

FIG. 2 depicts a high-level block diagram of a server system suitable for facilitating a network management (NM) tool, in accordance with the principles of the present invention. Specifically, the NM tool 140 of FIG. 2 resides in a server system 201, which comprises a processor 202, support circuits 206, I/O circuits 208, a storage device 212, as well as memory 204 for storing various control programs such as the NM tool 140. The storage device 212 is a non-volatile storage device, such as a disk drive or an array of disk drives for permanently storing programs such as the operating system, application programs (e.g., an http server application, diagnostics engine, web browsers, and the like), as required

The processor 202 may be one or more microprocessors, such as an Intel Inc., PENTIUM® processor. The memory 204 may be random access memory (RAM), which is used during operation to store the diagnostic engine 142, the polling agent 144, and the operating system 210. The processor 202 cooperates with conventional support circuitry 206 such as power supplies, clock circuits, cache memory and the like as well as circuits that assist in executing the software routines stored in the memory 204. As such, it is contemplated that some of the process steps discussed herein as software processes may be implemented within hardware, for example as circuitry that cooperates with the processor 202 to perform various steps. The server system 201 also contains input/output (I/O) circuitry 208 that forms an interface between the various functional elements communicating with the NM tool 140.

In one embodiment, the NM tool 140 incorporates a robust and widely deployed SNMP agent and web server application, such as the ASG-Sentry platform application produced by Allen Systems Group, Inc. of Naples, Fla. Although the tool platform application for the preferred embodiment described in this application is the ASG-Sentry platform application, those skilled in the art will appreciate that other web-enabled SNMP browser systems may also be utilized as the application platform upon which the present invention is structured. Similarly, it would also be known to those skilled in the art that a completely proprietary web-enabled SNMP browser system may also be utilized as the application platform upon which to build the present invention.

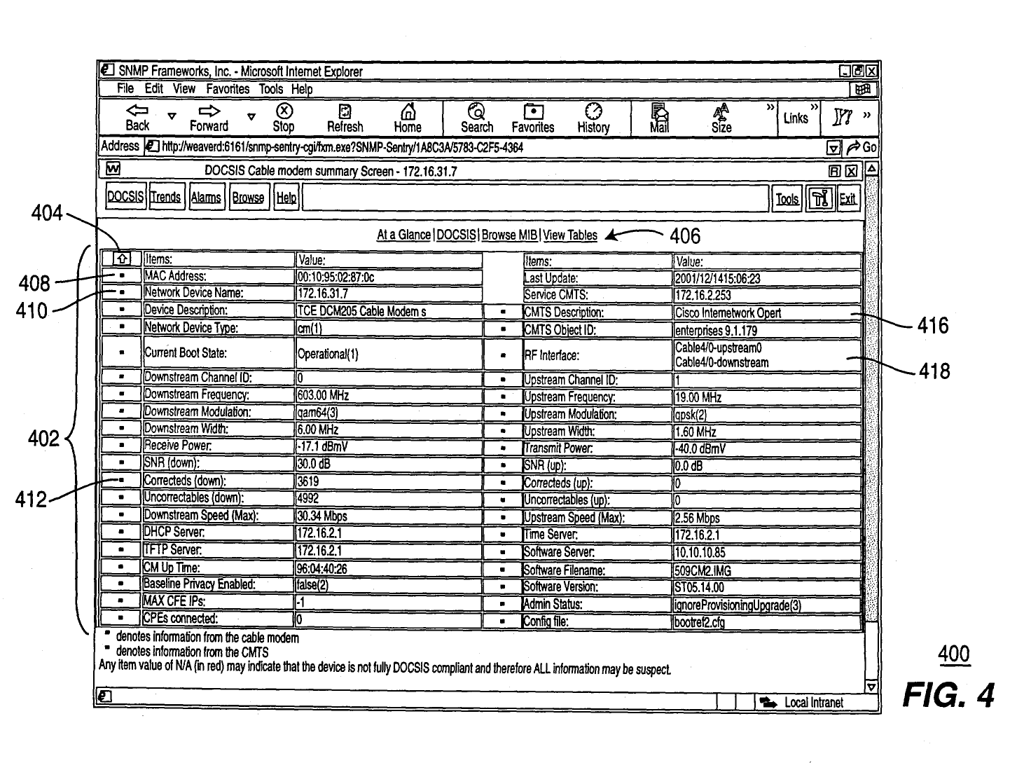

The diagnostics engine 142 may be used to retrieve MIB objects, such as those stored in the CMTS-CM status table 131 at each CMTS 130 for display on a web page. An example of various MIB objects and the diagnostic tool screen layout are illustrated and discussed in detail below with regards to FIGS. 4-10.

The SNMP polling agent 144 provides SNMP communications from the diagnostic engine 142 to the CMTSs 130, as well as the cable modems 122 on the network 100. The http server application 150 provides a means by which many remote clients on the network 100 (i.e., service representatives accessing their workstations 126) can simultaneously use the diagnostic engine 142 using a standard web browser application 158 that is installed on the workstations 126. As such, the cable service representatives of the MSOs (and Internet service providers (ISPs)) may simultaneously access the centralized diagnostic engine 142 on a centralized NM tool 140 to conduct cable modem diagnostics and troubleshooting of different customer issues from their standard web browsers 158 at their workstations 126.

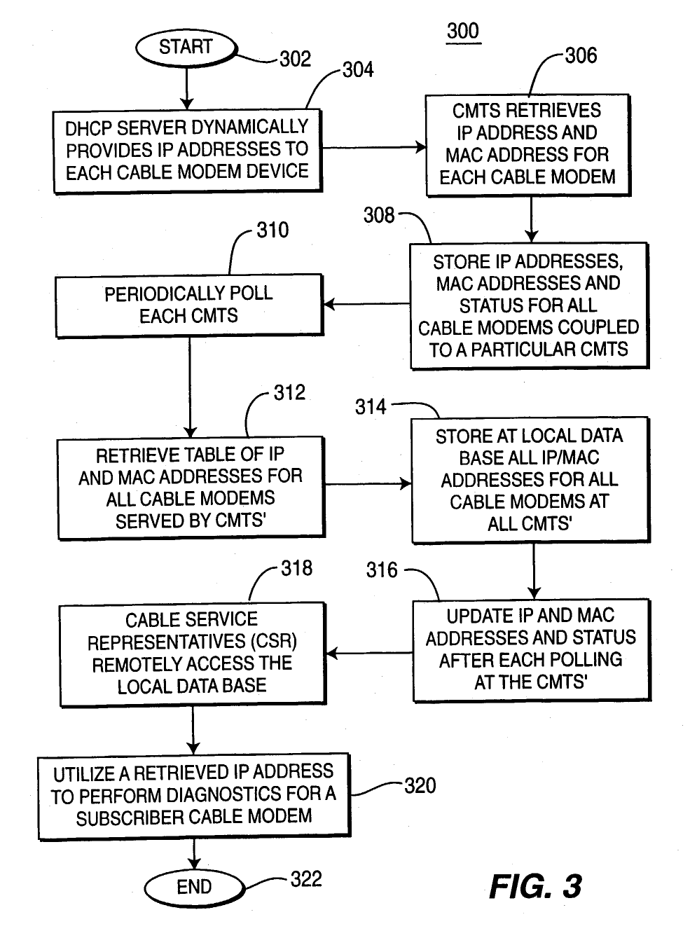

FIG. 3 depicts a flow diagram of an exemplary method for acquiring respective IP addresses of a plurality of cable modems, in accordance with the principles of the present invention. The method 300 starts at step 302, where all of the CMTSs 130 and their respective IP addresses in the system 100 have been entered by a tool administrator and stored in the local CMTS database 149 at the NM tool 140, as discussed below in further detail with regard to FIG. 5. Additionally, the MAC addresses of each cable modem the MSO has provisioned for coupling to each CMTS 130 have been entered and stored in the DHCP Server 132 at each CMTS 130.

Steps 304, 306 and 308 take place dynamically, and automatically, per DOCSIS requirements, modem by modem, each time a CM is installed into the Access Network 108. At step 304, the DHCP server 134 at the head end 110 dynamically allocates an IP address to the cable modem 122. At step 306, the CMTS 130 gleans the CM MAC and IP address from the DHCP communication passing through it. At step 308, the MAC address, IP address, and current CM connectivity status with the CMTS 130 are stored in the CMTS-CM status table 131 of the CMTS 130 to which the cable modem 122 is respectively coupled.

Since the IP address of each cable modem 122 is dynamically allocated, such IP addresses are subject to change, for example, on a daily basis. The NM tool 140 maintains the status of the IP addresses by periodically polling the CMTS-CM status table 131. Polling is a method of accessing and retrieving (i.e., gleaning) information from a database, such as the CMTS-CM status table 131. At step 310, the diagnostics tool periodically polls each CMTS 130 in a round-robin (staggered) fashion. In one embodiment, the polling at each CMTS occurs approximately every fifteen minutes. The polling is performed by the polling agent 144 as a background operation. Staggering the polling using the round-robin technique during background operations helps to avoid bandwidth bottlenecks, which may occur if two or more CMTSs 130 are polled simultaneously.

At step 312, the NM tool 140 retrieves the IP addresses and MAC addresses for all of the cable modems 122 coupled to each CMTS 130. That is, the diagnostic engine 142 instructs the polling agent 144 to access the CMTS-CM status table 131, and at step 314, stores the IP and respective MAC addresses for each cable modem 122 locally, in the local CM database 146 at the NM tool 140. It is noted that the MAC address and IP address for any DOCSIS compliant cable modem is retrieved, regardless of the manufacturer of the cable modem 122.

As such, method 300 provides a technique for the NM tool 140 to acquire the IP addresses of the cable modems 122 from the CMTSs 130 in the system 100 without incurring additional requirements on the CMTSs 130 or cable modems 122. That is, the NM tool 140 utilizes resources (e.g., the CMTS-CM status table 131) that are readily available per the DOCSIS requirements in the cable system 100. At step 316, the polling agent 144 continues to poll the CMTS-CM status tables 131 of each CMTS 130 in a round-robin manner as described above. Each time a CMTS 130 is polled, the IP address and MAC addresses for each cable modem 122 are retrieved, such that the local CM database 146 may be periodically updated. At step 318, a customer service representative (CSR) may remotely access the local CM database 146 at the NM tool 140 and retrieve the IP address and current connectivity status of a particular cable modem 122 of interest, given only the MAC address printed on the CM label. At step 320, the diagnostic engine 142 utilizes the retrieved IP address to perform diagnostics for the cable modem of interest, and at step 322, the method 300 ends.

FIG. 4 depicts an exemplary diagnostic tool's cable modem summary screen 400, in accordance with the principles of the present invention. The screen 400 is a web-browser based screen such as one provided by Microsoft Internet Explorer. The cable service representative (CSR) activates their web browser 158 on their workstation 126 and enters the uniform resource locator (URL) of the NM tool program 140. The CSRs are able to log into the NM tool program 140 after providing proper authentication and password verification. That is, logging-in can be performed from a web browser 158 operating on any user PC 126 that has IP connectivity with the http server application 150, or from a web browser installed on the server system 201. Using the world-wide-web protocol (http), the diagnostic engine 142 in conjunction with the SNMP polling agent 144 then provides a resource such as the HTML page shown in FIG. 4. It is noted that the service representatives may remotely access the NM tool 140 from any location where they have access to a web browser 158.

In one embodiment, the exemplary web-based screen 400 comprises a table 402 that provides various MIB objects (items) and values of a particular cable modem 122 coupled to a CMTS 130. For example, the standardized MAC address 408 of a selected device, such as a cable modem 122, has an illustrative 6 byte hexadecimal address of “00:10:95:02:87:0c”, where the first three bytes identify the manufacturer of the device. The current IP address 410 of this exemplary cable modem 122 is 172.16.31.7. The table 402 shown on screen 400 illustratively provides the most important MIB objects out of the hundreds of possible MIBs for this particular cable modem 122. For example, a selected top “40” MIB objects shown on the screen 400 are those that are considered most useful for initially diagnosing a cable modem 122.

A service representative may also view any of the other MIBs not included in the top 40 listing on a similar screen shown in FIG. 4 by navigating through various screens that provide different information regarding the devices in the network 100, such as the cable modems and CTMSs. A title bar 406 offers the CSR choices of some of the screens and tables that are available for viewing from the screen 400, some of which are illustratively shown in FIGS. 5-10. For example, clicking the “view tables” allows a user to see a directory structure showing all tables in compiled MIBs. The CSR can then select (e.g., drill down though various screens) to any desired table to read its current values for the selected device. Further, clicking on the “browse MIB” allows the user to see a directory structure showing all MIB objects in the compiled MIBs, in the tree structure matching their MIB Object Identifiers (OIDs).

The user can then drill down though various screens to any desired MIB object to read its current value for the selected device. The “up-arrow” 404 on the upper left portion of the table 402 may be clicked on to allow a user to go back to a previous screen. The up-arrow button is on all of the screens to enable the user to return to a previously viewed screen in a similar manner as provided by the “BACK” button as used on commercially available web browsers.

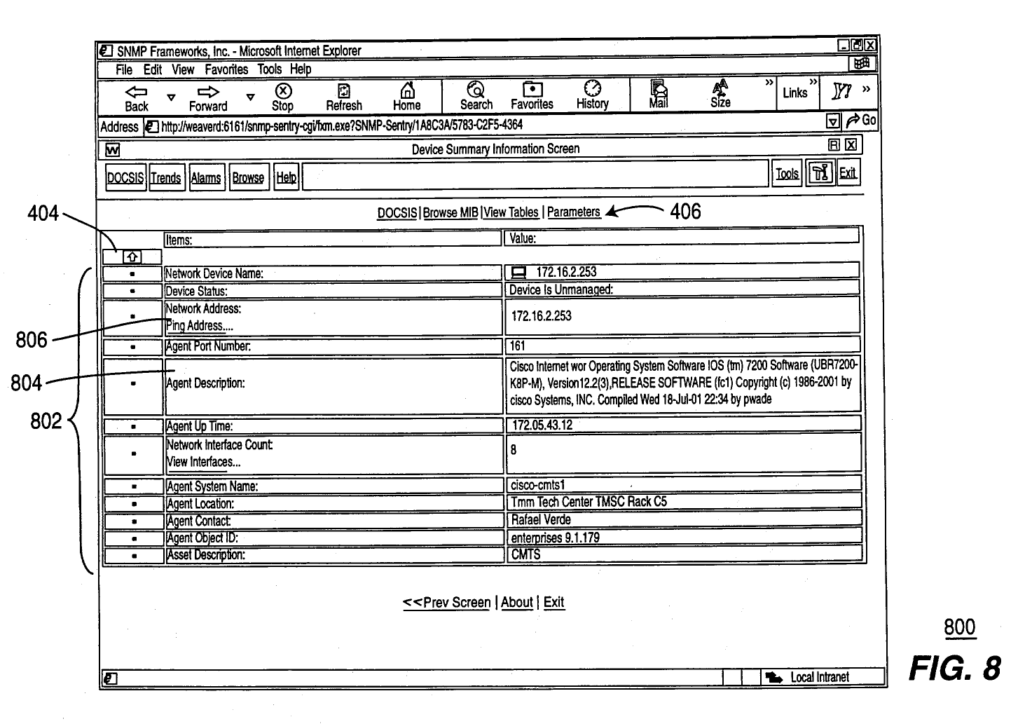

The diagnostic engine 142 also provides hyperlinks to describe selected MIB's in greater detail. In particular, those items that are underlined (e.g., the underlined MAC address 408) have hyperlinks to other web pages describing the particular MIB object functionality and features. The information displayed on the screen 400 of FIG. 4 may be used to help a service representative resolve a problem with a particular device, such as a cable modem 122 and/or a CMTS 130. For example, clicking on the hyperlink for the service CMTS 416 initiates a new screen providing information specific for that selected CMTS (e.g., screen 800 of FIG. 8 as discussed below).

Other links are also provided on the screen 400 that allow the user to retrieve information associated with the cable modem that is coupled to the CMTS (e.g., the CMTS 130 IP address of 172.16.2.253), as well as to see all other devices in the same “neighborhood” as the one displayed. For example, the RF interface object 418 allows a customer service representative to view additional cable modems 122 that are sharing the same port at the head-end 110. Specifically, the RF Interface item 418 provides a list of “neighbors” to this CM, i.e. other modems using the same CMTS downstream or upstream RF channel. Such information may be useful to a cable service representative during comparison troubleshooting to help determine whether a problem is common to a particular cable modem 122 or multiple cable modems 122.

FIG. 5 depicts an exemplary diagnostic tool's CMTS registration screen 500, in accordance with the principles of the present invention. A system administrator utilizes the registration screen 500 to enter all of the CMTSs 130 at each head-end 110 in the system 100 during initial installation of the NM tool 140 on the server system 201. More specifically, the IP address and other information for each CMTS 130 in the system 100 is entered via the registration screen 500 and stored in the local CMTS database 149. It is noted that the diagnostics engine 142 requires the IP address of the CMTSs 130 to access and retrieve the information in each CMTS-CM status table 131. The registration screen 140 may also be is used when one or more CMTSs 130 are added to or removed from a head-end 110 in the system 100.

The CMTS registration screen 500 comprises a toolbar 502 for navigating through the diagnostics tool, a field entry row 504, and a table of CMTSs 130 currently stored in the local CMTS database 149. The field entry row 504 comprises a plurality of fields where a diagnostics tool administrator may enter for each CMTS added to the CMTS database 149, a CMTS IP address, CMTS region, CMTS read community string, and default CM read community string. An add/update button 520 stores the data entered in the field entry row 502 in the database 146. Once stored, the newly added CMTS is shown below in a table listing 506 along with any other CMTSs 130 entered into the database. The table listing 506 comprises a plurality of fields including a status field 508, a CMTS IP address field 510, a CMTS region field 512, a CMTS read community string field 514, agent name field 516, and a default CM (cable modem) read community string field 518.

In particular, the status field 502 indicates whether the CMTS is responding to periodic SNMP polling by the NM tool 140. The CMTS IP address 510 displays the IP address for each CMTS 130, which is required for the NM tool 140 to communicate with a particular CMTS 130. The CMTS region field 512 indicates the geographical region where a particular CMTS 130 is located. Specifically, the regions are identifying text strings that allow the tool administrator to group CMTSs 130 in some logical structure as desired.

The CMTS read community string 514 provides the password that the NM tool 140 must include in every SNMP communication with the CMTS 130. The agent name 516 provides the network administrator assigned CMTS human-readable name. The default CM read community string provides the password that the NM tool must include in every SNMP communication with CMs serviced by this CMTS 130. It is noted that the up-arrow 404 is provided to navigate to previous screens, while hyperlinks are provided in the CMTS IP address field 510 to navigate to a screen such as shown in FIG. 8 to view information related to a particular CMTS 130.

Further, a remove button 522 allows an administrator to remove a CMTS 130. It is noted that a CMTS 130 that is already listed may be updated, for example, changing the CMTS assigned region 512 by reentering the information in the field entry row 504 and by clicking on the update button 520.

The regions are identifying text strings that allow the tool administrator to group CMTSs 130 together as desired. Storing the CMTSs 130 by their geographic region allows the tool to stagger the polling of CMTSs by region, or demand poll just one region for an immediate update, so as not to poll every CMTS at the same time, which would diminish bandwidth capacity and performance of the system 100.

As discussed above, a problem common to all known tools is that the tools require a device's (cable modem, CMTS, or any other device coupled to the Internet) IP address to operate. A device's IP address is used by the diagnostics tools to make the SNMP queries to the device. For a DOCSIS-compliant CM 122, the IP address is not readily available to the customer service representative. Rather, the service representative must first determine the IP address of a subject device (e.g., cable modem) from other sources, which may not be readily available. Specifically, the IP addresses are dynamically provided by the DHCP server 132, and are subject to change. For example, the IP address of a cable modem 122 may change because the modem was moved from one subscriber to another, the CM or CMTS rebooted due to power interruption or signal loss, the DHCP server rearranged management of the available pool of IP addresses, and the like. The NM tool 140 of the present invention remedies the problem of not knowing the IP address of a device at any given time by resolving the MAC address printed on the CM label to its dynamically assigned IP addresses. This feature enables a customer to simply read the MAC address on the back of the cable modem 122, and the service representative can then query the CM by simply entering that MAC address into the NM tool 140. The tool then automatically converts the MAC address to the corresponding IP address to perform diagnostics and troubleshooting.

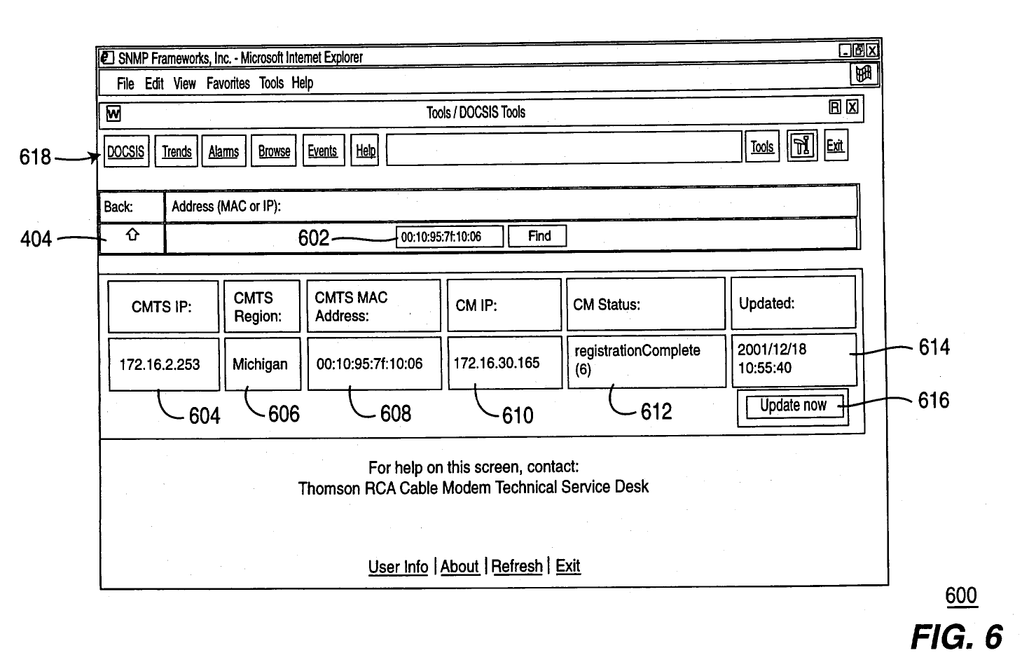

FIG. 6 depicts an exemplary diagnostic tool's search screen 600, in accordance with the principles of the present invention. The search screen 600 is also a web-based screen. In particular, the NM tool 140 allows the user (i.e., service representatives) to search for a particular device in the cable system 100 by providing either the IP address, if known, or the MAC address into the web page 600 displayed by the tool 140. The NM tool 140 is able to identify and locate a device such as a cable modem 122 by either the IP address or MAC address.

In one embodiment, the search screen 600 comprises a tool bar 618, a MAC/IP address entry field 602, a CMTS IP address field 604, a CMTS region field 606, a CM MAC address 608, a cable modem IP address field 610, a cable modem status field 612, a last-updated date and time field 614, and an update button 616.

The MAC/IP address entry field 602 allows a service representative to enter either the MAC address or IP address to perform a search for the device associated with such address. In most instances, a CSR will not have the IP address, since the IP address is dynamically assigned and subject to change. However, during a customer service call, the CSR can ask the customer to read the MAC address from a label on the outside of the customer's cable modem 122, and the CSR just types in the MAC address in the entry field 602 for resolution to a current IP address. Once the CSR enters a cable modem's MAC address on the appropriate screen 600, the information is gathered by scripts and displayed on the screen 600. This information includes the cable modem IP address 610, as well as the IP address of the CMTS 604 to which the cable modem is coupled, the CMTS region 606, and cable modem status 612. The service representative is then able to click on the IP address hyperlink (e.g., the CMTS IP address 604 or the cable modem IP address 610 hyperlinks) and view additional informational screens associated with the CMTS 130 or cable modem 122, including the summary screen 400 mentioned above with regard to FIG. 4.

If a MAC address search comes up without a result for a particular cable modem, it is possible that the cable modem 122 has not been operating long enough for the polling function to have detected its presence in the system 100. In this instance, the user may force an immediate polling of the selected CMTS to expedite location of the target cable modem.

In particular, when an update button 616 on the screen 600 is activated, the NM tool 140 polls the CMTS-CM status table 131 of a selected CMTS 130 immediately thereafter, rather than having to wait for the default polling time (e.g., 15 minutes) to update the status of the cable modems 122 respectively coupled to the selected CMTS 130. As such, a customer service representative who is providing support to a customer can quickly update a portion of the local CM database 146 by selecting a specific CMTS or region, as opposed to polling all of the CMTSs 130, which is much more time consuming, as well as an inefficient use of bandwidth.

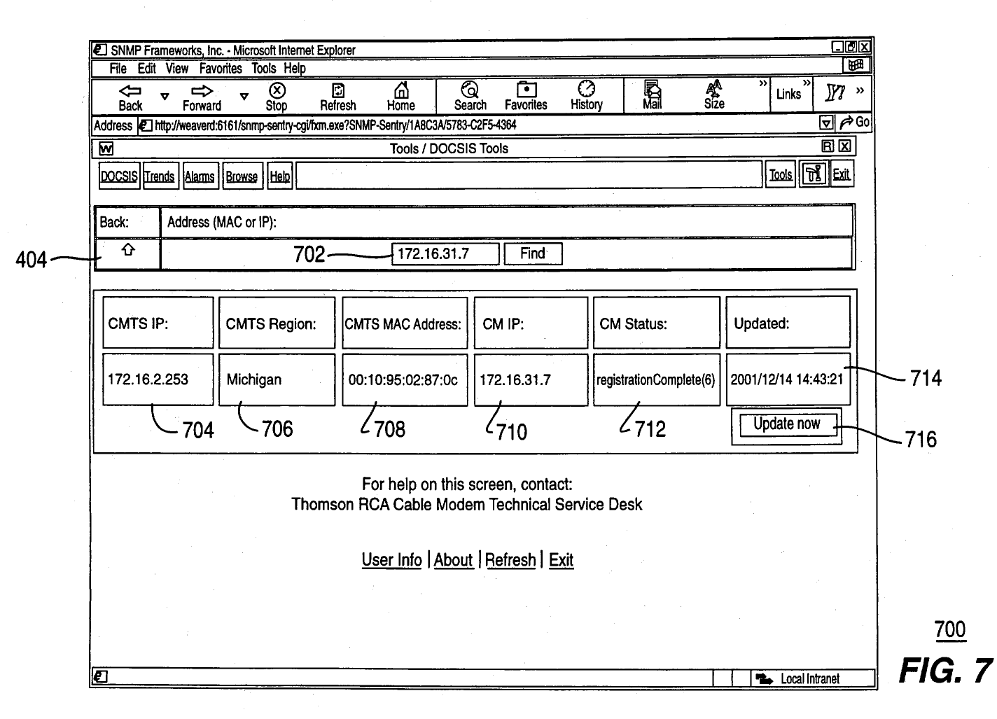

FIG. 7 depicts an exemplary diagnostic tool's cable modem search screen 700, in accordance with the principles of the present invention. For purposes of understanding the invention, it is assumed that a cable modem (CM) 122 at known IP address 172.16.31.7 is currently online and registered. To find out what CMTS 130 is serving the CM and view diagnostic information about the CM, the target address “172.16.31.7” is entered in the entry field 702. The screen 700 displays the serving CMTS IP address (with hyperlink) 704, the serving CMTS region (e.g., Michigan) 706, the target CM MAC address 708, the CM IP address (with hyperlink) 710, the target CM status 712, and the last update time 714. The CM status 712 provides CM initialization status information, such as registration complete, access denied, IP complete, ranging complete, and the like. The last update time 714 provides date and time of when the target cable modem 122 was last polled (i.e., automatically or manually). In this example, note the serving CMTS IP address 702 is revealed to be 172.16.2.253. However, it is possible that more than one CMTS will report knowledge of a single CM, for example, if that CM has been recently moved from one CMTS to another CMTS.

Specifically, the original CMTS may still consider the CM to be (possibly) “out there” but currently offline. This is because the CMTS-CM status able 131 in the original CMTS maintains a list of all CM's that the original CMTS believes may still be physically connected to it, whether currently online or not. After a CM has been offline for some time (hours or days, depending upon CMTS configuration), the original CMTS finally de-learns knowledge of an offline CM. Multiple hits mean multiple CMTS's have recently seen the CM, however, only one CMTS will show the CM as currently online/operational.

Where two or more CMTSs report the target CM “online”, the latest value in the CM status field 712 may be used to discern the actual CMTS that the target CM is coupled. If desired, an immediate poll of all known CMTS's can be triggered to bring up to date the status of the target CM for each CMTS listing. From an immediate poll, only one CMTS should report this value as “registrationComplete(6)”, which represents the CMTS 130 that is currently serving the target CM 122.

FIG. 8 depicts an exemplary diagnostic tool's device summary information screen 800 for a CMTS 130, in accordance with the principles of the present invention. In particular, the CSR may click the CMTS IP hyperlink 172.16.2.253 field 704 of FIG. 7 to view useful system description information about the CMTS serving the target CM. The exemplary device summary information screen 800 includes the up-arrow 404 and a title bar 406 as discussed above with regard to FIG. 4. Table 802 comprises various fields regarding the agent, which in this case is the service CMTS. For example, an agent description 804 shows that the exemplary operating software (OS) version is “Cisco Internetwork OS”. Further, the hyperlink “Ping Address” 806 may be used to ping the service CMTS to ascertain connectivity.

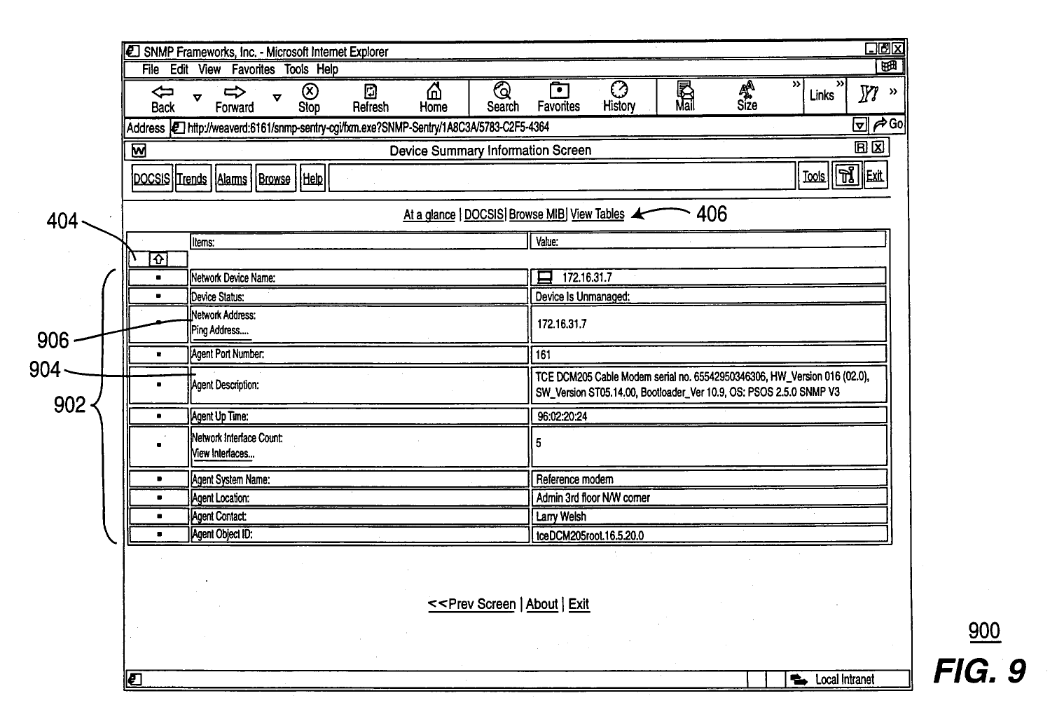

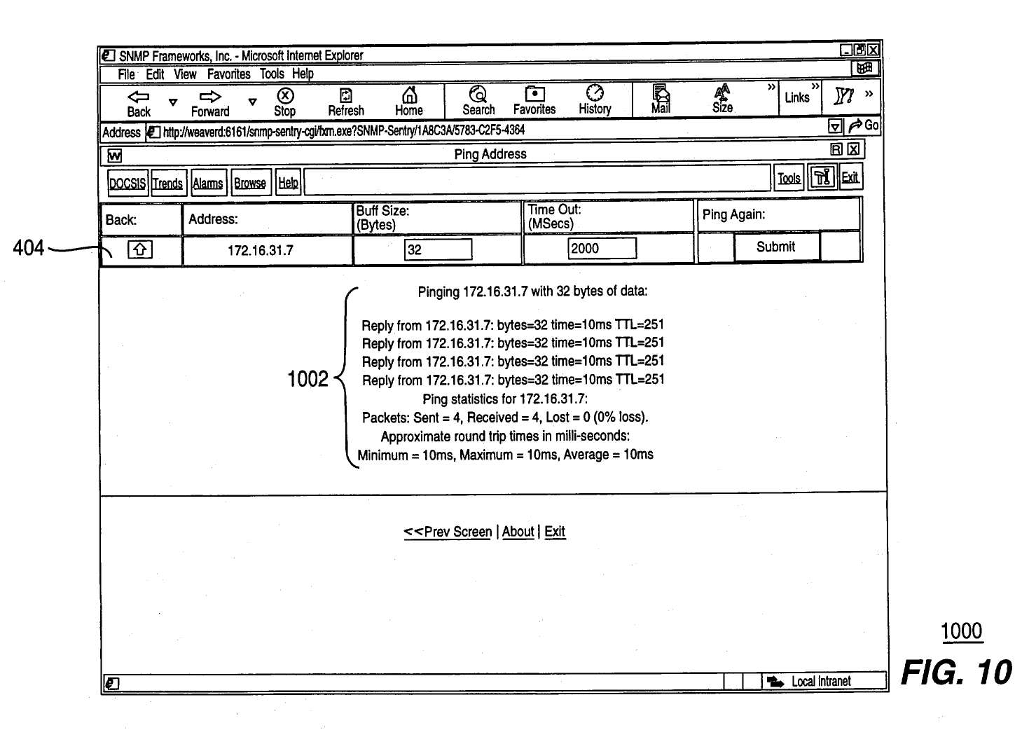

FIG. 9 depicts an exemplary diagnostic tool's device summary information screen 900 for a cable modem 122, in accordance with the principles of the present invention.. The exemplary summary information screen 900 provides a table 902 comprising useful system description information about the target CM, including manufacturer, model and serial number. For example, the agent description field 904 lists a TCE DCM205 model cable modem manufactured by Thomson Consumer Electronics, Inc., of Indianapolis, Ind. Further, a CSR may click on the “At a Glance”hyperlink in title bar 406 at page top center to bring up the screen 400 illustratively shown in FIG. 4. As discussed above, this screen 400 shows a vast array of information pulled from CM and CMTS about this CM's current operation. In one embodiment, a green dot 412 before a field indicates information gleaned by SNMP from the CMTS, while a red dot (for purposes of clarity, illustrated with an “X”) 414 indicates the information was learned from the CM itself. Further, the hyperlink “Ping Address” 906 may be used to ping the target cable modem to ascertain connectivity, as shown below in FIG. 10.

FIG. 10 depicts an exemplary screen 1000 illustrating results of pinging a particular address, in accordance with the principles of the present invention. Clicking on the hyperlink “Ping Address” 906 brings up the screen 1000 shown in FIG. 10. For example, when pinging the cable modem at IP address 172.16.31.7, four exemplary packets were sent and received, while none were lost. The pinging address field 906 of screen 900 may be useful during instances where, during an attempt to query a CM, the title bar 406 containing the “At a Glance” option doesn't appear, which means the CM is not responding. If the cable modem responds after clicking on the pinging address field 906, then perhaps the cable modem has been set (via config file) to expect a different community string than being used. As such, the CSR can investigate the correct community string for the target cable modem. It is noted that clicking the up-arrow 404 at page top left returns the user to the previous screen, for example, the cable modem lookup screen of FIG. 7. Referring to FIG. 7, clicking the CM IP hyperlink 710 initiates a device summary information screen for the target cable modem 122 as shown in FIG. 9.

As such, the custom functions and screens provided by the NM tool 140 are optimized for observation of DOCSIS cable modem systems. The NM tool 140 is a useful device to provide network management and assist cable operator, cable ISP operations, and help desk personal to support and diagnose the cable modem system 100 from remote locations without knowing the IP address of a device. Rather, the NM tool 140 is able of resolve a dynamically assigned IP address of a device (e.g., cable modem) from a readily available MAC address, and then provide pertinent diagnostics information for such device.

Although various embodiments that incorporate the teachings of the present invention have been shown and described in detail herein, those skilled in the art may readily devise many other varied embodiments that still incorporate these teachings.

What is claimed is:

1. A method, comprising:
retriving IP addresses provide to each of a plurality of bi-directional communication devices respectively coupled to at least one termination system (TS);
associating said retrieved IP addresses with respective media access control (MAC) addresses; and
storing indicia of updated association of retrieved IP addresses and MAC addresses in a local database.

2. The method of claim 1, further comprising:
utilizing an IP address remotely accessed from said local database to perform diagnostics for a subscriber bi-directional communication device.

3. The method of claim 1 wherein said associating step further comprises:
initially storing said IP addresses and associated MAC addresses in a status table at said TS.

4. The method of claim 3 wherein said associating step further comprises polling said status table at said TS.

5. The method of claim 4, wherein said polling step further comprises:
polling said status table periodically.

6. The method of claim 5, wherein said status table is periodically polled at about fifteen minute intervals.

7. The method of claim 4, wherein said polling step further comprises utilizing a simple network management protocol (SNMP) agent over an IP network.

8. The method of claim 2, wherein said remotely accessing step comprises enabling at least one customer service representative (CSR) to access said local database from remotely located web browsers installed on computer devices.

9. The method of claim 4, wherein:
said bi-directional communication device comprises a cable modem; and
said termination system comprises a cable modem termination system (CMTS).

10. The method of claim 9, wherein said polling step further comprises retrieving cable modem information of any data over cable service interface specification (DOCSIS) compliant cable modem.

11. The method of claim 4, wherein said polling step comprises:
enabling retrieval of information placed in Internet Engineering Task Force (IETF) experimental branch management information base object identifiers (MIB OIDs); and
enabling retrieval of information placed in IETF permanent branch MIB OIDs.

12. A method for performing bi-directional communication device (BCD) remote diagnostics and network management,comprising:
retrieving, IP addresses dynamically provided to a plurality of subscriber BCDs respectively coupled to at least one termination system (TS) at a head end;
associating said IP addresses of said plurality of BCDs with respective media access control (MAC) addresses of said plurality of BCDs;
storing said IP addresses and associated MAC addresses in a status table at said TS;
polling said status table; and
storing said polled status table at a local database.

13. The method of claim 12, further comprising:
remotely accessing said local database; and
utilizing a retrieved IP address to perform diagnostics for a subscriber BCD.

14. The method of claim 12, wherein said polling step further comprises:
polling said status table periodically.

15. The method of claim 12, wherein said status table is periodically polled at about fifteen minute intervals.

16. The method of claim 13, wherein said remotely accessing step comprises enabling at least one customer service representative (CSR) to access said local database from remotely located web browsers installed on computer devices.

17. The method of claim 12, wherein:
said BCD comprises a cable modem; and
said termination system is a cable modem termination system (CMTS).

18. The method of claim 12, wherein said polling step further comprises utilizing a simple network management protocol (SNMP) agent over an IP network.

19. Apparatus for performing remote bi-directional communication device diagnostics and network management, comprising:
means for retrieving IP addresses dynamically provided to each of a plurality of bi-directional communication devices respectively coupled to at least one termination system (TS);
means for associating said retrieved IP addresses with respective media access control (MAC) addresses; and
means for storing indicia of updated association of retrieved IP addresses and MAC addresses in a local database.

20. The apparatus of claim 19, further comprising:
means for utilizing an IP address remotely accessed from said local database to perform diagnostics for a subscriber bi-directional communication device.
